(19) United States
(12) Patent Application Publication
(10) Pub. No.: US 2005/0202382 A1
(43) Pub. Date: Sep. 15, 2005

(54) Method and system for managing teaching files

(75) Inventors: Daniel J. Rahn, Waterloo (CA); Michael W. Eppel, Kitchener (CA)

Correspondence Address: FASKEN MARTINEAU DUMOULIN LLP, 4200 TORONTO DOMINION BANK TOWER, BOX 20 TORONTO-DOMINION CENTRE, TORONTO, ON, M5K 1N6, CA

(73) Assignee: AGFA INC.

(21) Appl. No.: 11/059,520

(22) Filed: Feb. 17, 2005

Related U.S. Application Data
(60) Provisional application No. 60/551,360, filed on Mar. 10, 2004.

(51) Int. Cl. G09B 23/28

(52) U.S. Cl. 434/262; 434/323

(57) ABSTRACT

There is disclosed a method and system for managing teaching files in a medical imaging system. In an embodiment, the method includes allowing selection of an element from a medical imaging database, isolating predetermined data from the selected element, and allowing indication of a teaching file in which to place the selected element. The placement may include determining if the selected element is related to a previously placed element in the indicated teaching file. In dependence upon at least one use characteristic of the teaching file, predetermined data for the selected element may be isolated, such that access to data that may identify a patient as a specific individual may be controlled.

This application claims the benefit of U.S. Provisional Application No. 60/551,360 filed on Mar. 10, 2004. The contents of the provisional application are incorporated by reference herein.

### BACKGROUND

The present invention relates to a method and system for managing teaching files. More specifically, the present invention is concerned with a method and system for managing teaching files in a medical imaging system.

Teaching files have been an important source of information used in medical training. In a digital environment, teaching files are just as important. Generally, teaching files are formed by, for example, gathering and combining interesting medical cases or parts thereof together in a form that may then be used to teach various persons. For example, a teaching file may be used to teach a training radiologist how to capture and identify a specific pathology. A teaching file may be used to show an x-ray technician examples of poorly acquired images, and how to avoid them. Teaching files may also be used by researchers to document cases for clinical trials.

Various designs for managing digital teaching files have been developed. However, heretofore, prior designs for managing teaching files have not adequately provided for the management of certain standardized formats for images stored in medical imaging systems (such as the Digital Imaging Communications in Medicine or DICOM standard), or provided for the integration of teaching files with picture archiving and communications systems (PACS) for case input, viewing and the like. As well, prior designs for managing teaching files may not have adequately addressed patient confidentiality.

Therefore, there remains a need in the art for an improved method and system for managing teaching files.

### SUMMARY

Generally, the present invention relates to a method and system for allowing a user to view, create, and otherwise manage a set of teaching files. Teaching files preferably include actual diagnostic images rather than, for example, lower resolution copies thereof. According to embodiments of the invention described herein, the teaching files may make use of actual diagnostic images by including copies of original studies, series and/or images and/or maintaining a reference/pointer to the original studies and/or images. The teaching files may also allow users to define any number of classification mechanisms. Further, the teaching files may be configured to protect sensitive patient information.

In an aspect of the invention, there is provided a computer implemented method for managing teaching files in a medical imaging system, comprising: allowing selection of an element from a medical imaging database; allowing indication of a teaching file for placement of a selected element; isolating, in dependence upon at least one use characteristic of the teaching file, predetermined data associated with the selected element, such that access to the predetermined data through the teaching file is controlled.

In an embodiment, the method further comprises determining if the selected element is related to a previously placed element in the indicated teaching file, and if so, isolating corresponding predetermined data from the selected element in dependence upon established criteria for placement into the teaching file.

In another embodiment, the isolating comprises copying the selected element without the predetermined data.

In another embodiment, the isolating comprises hiding access to the predetermined data.

In another embodiment, the method further comprises maintaining a hidden link to the predetermined data.

In another embodiment, the predetermined data is any data field identifying a patient as a specific individual.

In another aspect of the invention, there is provided a system for managing teaching files in a medical imaging system, comprising: means for selecting an element from a medical imaging database; means for indicating a teaching file for placement of a selected element; means for isolating, in dependence upon at least one use characteristic of the teaching file, predetermined data associated with the selected element, such that access to the predetermined data through the teaching file is controlled.

In an embodiment, the system further comprises means for determining if the selected element is related to a previously placed element in the indicated teaching file, and if so, isolating corresponding predetermined data from the selected element in dependence upon established criteria for placement into the teaching file.

In another embodiment, the means for isolating comprises means for copying the selected element without the predetermined data.

In another embodiment, the means for isolating comprises means for hiding access to the predetermined data.

In another embodiment, the system further comprises means for maintaining a hidden link to the predetermined data.

In another embodiment, the predetermined data is any data field identifying a patient as a specific individual.

In another aspect of the invention, there is provided a computer readable medium containing software instructions which, when executed in a computer, may be used to manage teaching files in a medical imaging system, comprising: instructions for allowing selection of an element from a medical imaging database; instructions for allowing indication of a teaching file for placement of a selected element; instructions for isolating, in dependence upon at least one use characteristic of the teaching file, predetermined data associated with the selected element, such that access to the predetermined data through the teaching file is controlled.

In an embodiment, the predetermined data is any data field identifying a patient as a specific individual.

Further aspects of the present invention including advantages and features will become more apparent upon reading of the following non-restrictive description of embodiments thereof, given by way of example with reference to the accompanying drawings.

### BRIEF DESCRIPTION OF THE DRAWINGS

In the appended drawings:

FIG. 1 is an illustration of a screen display of a system for managing teaching files according to an embodiment of the present invention;

FIG. 2 is an illustration of a finder grid search window for searching for/within a teaching file;

FIG. 3 illustrates a separate search form;

FIG. 4 illustrates a CD export form; and

FIG. 5 illustrates a Teaching File Comments form.

### DETAILED DESCRIPTION

The following describes embodiments of a method and system for managing teaching files as used with medical images and patient information stored in a clinical image archive (such as a PACS, for example).

According to an embodiment of the invention, elements of a clinical or medical database of real cases, including DICOM data, may be selected for inclusion in an indicated teaching file. Sensitive patient data may be isolated from inclusion in the teaching file by either removing it from data copied to the teaching file, or by blocking access to it in the event that data is not copied.

Classification of the selected elements may be facilitated through a hierarchical directory structure for each teaching file. Classification may further be based on a body part or on a disease category, for example.

The system and method may allow for the adding of an element to a teaching file as a “study”, a “series” or an “object” which may comprise, for example, an image, a report, a movie or a sound.

Since elements may be added to a teaching file at the level of studies, series or objects, it may be contemplated that only select predetermined data from a clinical or medical database may be used. Further, this may be done in such a way that the teaching file may not necessarily include the whole of a real case, or of a number of cases. This may result in more efficient use of storage space in the event that copies of data are kept in a separate database area, or where a teaching file is stored onto portable media such as a recordable CD.

Moreover, where there is a pre-existing teaching file, selected elements may be added to the pre-existing teaching file by determining if the selected elements are related to previously placed elements in the pre-existing teaching file, and by placing them according to their relation thereof with previously placed elements. In such a way, where there is a relationship between a selected element and a previously placed element, the pre-existing teaching file may be updated such that the selected element and the previously placed element are associated with one another and/or stored together. By way of example, the relationship between a selected element and a previously placed element may be based on a body part, or a disease category, or some other common characteristic. As noted above, a pre-existing teaching file may have established criteria for isolating or blocking access to sensitive patient data. Thus, as new elements are selected for placement into a pre-existing teaching file, a common established criteria for isolating or blocking access to sensitive patient data may be used for placement into that teaching file.

As noted above, the selected elements may be placed in a teaching file by storing a copy thereof in a separate area of the database for teaching files or by storing a pointer (or the like) to the selected elements in the teaching file. Therefore, in case of a relationship between a selected element and a previously placed element in a pre-existing teaching file, as described hereinbefore, the teaching file may be updated such that a pointer to the previously placed element may be updated to also point to the selected element.

In any case, when elements are selected for placement in a teaching file, any data identifying a patient as a specific individual, including for example the patient's identification and the patient's name, may be isolated, and access thereto may be blocked. Other data, such as a body part examined, a patient's date of birth and/or a patient's gender, may be maintained for demographic purposes relating to the selected elements. In some cases, it may be useful to maintain a hidden, limited-access link to the original patient data for emergency use.

Teaching files, once created, may be copied for example to a recordable CD or the like, and viewed using a graphical interface, such as a GUI (graphics user interface). For example, the GUI may allow a user access to a teaching file directory, a content section and/or a summary section, as will be described further hereinbelow. Access conditions may be further determined in relation to each user.

As noted above, teaching files accessed through a graphical interface may or may not be linked to real/actual cases from which they may originate. In an embodiment, in order to ensure patient privacy, a teaching file may be provided with a link to the real case or real cases and possibly DICOM information, without the originating database and/or DICOM being viewable. For example, such a link may be provided in a private field of the teaching file control, so as not to be visible to a user, nor copied upon publishing/transfer of information to a CD for example.

The system for managing teaching files may generally comprise: a means for allowing a selection of elements from a medical imaging database; a means for identifying/isolating predetermined data from the selected elements; a means for allowing indication of a teaching file in which to place the selected elements; a means for placing the selected elements in the indicated teaching file, including means for determining if the selected elements are related to a previously placed element in the teaching file; and a means for placing selected elements according to their relationship with the previously placed element or previously placed elements.

The system may further comprise a means for storing a copy of the selected elements in a separate data area for teaching files. Further, the means for placing the selected elements in an indicated teaching file may allow selected elements to be added as studies, series or objects, as explained above. The means for determining if a selected element may be related to a previously placed element in the teaching file and the means for placing the selected element according to its relationship with previously placed elements may further allow that when a series or objects forming a study are added to a teaching file that already contains a series or objects belonging to the same study, the selected elements may be associated with or added to the existing series or objects.

The system may further comprise classification means defining a classification mechanism, based for example on a body part or on a disease category, for classification of selected elements, the studies, the series and/or the objects. Classification mechanisms may be tailored according to specific needs, such as for example, teaching training radiologists to capture and identify a specific pathology, teaching x-ray technicians to acquire suitable images, or documenting cases for clinical trials.

The system may further comprise display means, such as a graphical interface, which may allow a user to view a set of teaching files. The graphical interface may give access to a directory, a content section and/or a teaching file summary section.

The directory may further comprise teaching file folders containing the teaching files that may form a database of teaching files that may be searched. Further, there may be access conditions associated with each user, so that a given user may only view predetermined teaching files in a directory, for example.

In particular, the content section of the graphical interface may display the content of a currently selected teaching file or the contents of currently selected teaching files.

Further, the teaching file summary section may display data about a teaching file selected from the content section. The teaching file summary section may comprise a teaching file and a reference subsection, which may be opened by means of a URL link in a new window for example.

The teaching file system may further comprise a work list, a finder grid window and a search criteria window. The work list may be a list of teaching files that a user builds, and which may perform group functions comprising for example launch displays, CD downloads, deletion functions and copy functions. The finder grid and search criteria windows may further facilitate the searching of a searchable database.

The graphical interface may further comprise a search criteria window for specifying a teaching file name and/or a search criterion. As an example, when searching by folder name, only the corresponding teaching file folder and teaching file subfolders may be searched.

In searching, search criteria may comprise such things as a range of birth dates of patients or the birth date of a patent, the sex of patients or of a patient, a patients' age, an original patient location, a current patient location, an original modality where the images were acquired, a body part, a specialty, a study description, a reason for a study, a study comment, additional patient history and teaching file comments, for example.

A search result list may display all the results obtained from a given search that match the criteria set out in the search criteria window and/or the teaching file set out in the teaching file folder name entry.

According to a computer implemented method of the present invention, the system and/or method may be embodied in software, either as a stand alone piece of software or as a control/function that interacts with other software. In a particular implementation, the studies and the images may be referenced by a teaching file reference and may be maintained as a study standard comprising a PACS, such as IMPAX™. In an embodiment, a structure of the teaching file may be stored as a set of folders and files in tables.

A first table (illustratively referred to herein as a TEACHING_FOLDER table) may be provided which may contain pertinent information for each folder within a teaching file, set out in fields such as the following:
a string value (generally referred to as a FOLDER_REF) which may be used to reference each teaching folder individually;
a string value (generally referred to as a PARENT_FOLDER_REF) which may be related to a reference of the folder that this folder may be contained within;
a string value (generally referred to as a OWNER_ID) which may correspond to a user ID of a user who created the folder;
a string value (generally referred to as a TEAM_ID) which may correspond to a team ID that the user may belong to;
a string value (generally referred to as a FOLDER_NAME) which may correspond to a name of a folder that the user may be authorized to see;
a numeric value (generally referred to as a IDENTITY_ENCRYPTION_LEVEL); and
a text field (generally referred to as a FOLDER_COMMENTS) which may be used for any comments that the user decides to associate with a folder.

A second table (illustratively referred to herein as a TEACHING_FOLDER_ITEM table) may be provided which may contain pertinent information for each teaching file within a teaching file set for example:
a numeric value (generally referred to as a ITEM_REF) which may be used to reference each teaching file individually;
a numeric value (generally referred to as a ITEM_ORDINAL) which may be used to order files within a folder;
a string value (generally referred to as a FOLDER_REF) which may be related to a reference of a folder this file belongs in;
a string value (generally referred to as a ITEM_NAME) which may correspond to a name of the teaching file. It may be the name the user sees and may be created from a combination of the fields generally referred to as ITEM_REF-MODALITY-STUDY DESCRIPTION;
a string value (generally referred to as a OBJECT_TYPE) which may be used to determine what the record may be referencing (such as a study, a series, or an image);
a numeric value (generally referred to as a OBJECT_REF) which may contain a study reference of a study that a teaching file may reference;

a text field (generally referred to as a ITEM COMMENTS) which may contain for example the referenced study's patient ID, accession number, and study reference, as well as any comments and referenced links that a user may have added. Generally, by way of example, these items may be stored in an XML format such as the following:

```
<TEACHING_FILE>
<COMMENTS VALUE=“”/>
<REFERENCE_LINK>
  <AUTHOR VALUE=“”/>
  <TITLE VALUE=“”/>
  <URL VALUE=“”/>
</REFERENCE_LINK>
<PATIENT ID VALUE=“”/>
<ACCESSION NUMBER VALUE=“”/>
<STUDY REF VALUE=“”>
</TEACHING FILE>;
```

a numeric value (generally referred to as a ORIGINAL_REF) which may contain a study reference of an original study from which a teaching file may be created from. This generally is intended to prevent study/images from being added multiple times to the same folder;
a string value (generally referred to as a ORIGINAL_PATIENT_ID) which may contain a patient ID of a study from which the teaching file may have been created; and
a string value (generally referred to as a TF_COMMENT) which may contain a comment portion of the ITEM-COMMENTS, which may allow a search for teaching files using the comment contents.

A third table (illustratively referred to herein as a TEACHING_FOLDER_ACCESS table) may be provided which may contain read/write permissions for each folder in a teaching file, using for example the following fields:
a string value (generally referred to as a FOLDER_REF) which may contain a folder reference of a folder to which permissions may apply;
a string value (generally referred to as a ACCESS_TYPE) which may refer to whom a permission applies too, wherein for example it may have a value, for example such as: GLOBAL, which may apply to every user; PRIVILEGE, which may apply to all users of a similar privilege level; and USER, which may apply to a specific user.
a string value (generally referred to as a ACCESS_VALUE) which may correspond to an ACCESS TYPE, and may contain either a user name and/or privilege level;
a string value (generally referred to as a ACCESS_READ) that may be either a T or an F, wherein if the value is a T, a user(s) of an ACCESS TYPE may view the contents of a teaching folder;
a string value (generally referred to as a ACCESS_WRITE) which may be either a T or an F, wherein when the value is a T, a user(s) of the ACCESS_TYPE may create teaching folders and add teaching files to the teaching folder; and
a value (generally referred to as a ACCESS_SECURITY) which may specify access information for the data.

Yet another table (generally referred to as a TEACHING_FILE_BANNED_STATIONS table) may be provided which may contain a numerical value (generally referred to as a STATION_REF) which may be related to a station reference of the station or stations whose studies and/or images may not be added as a teaching file or teaching files.

### EXAMPLE

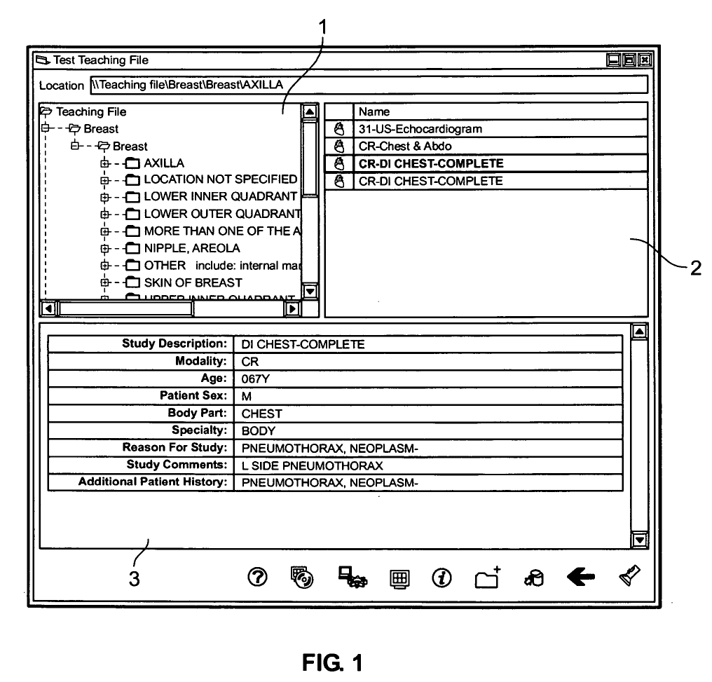

By way of example, FIG. 1 illustrates a teaching file control which may be launched by selection thereof in a study menu or by a selection in a display window or the like. In this example, the teaching file is an activex™ control that resides on a display form owned by a parent application. Alternately, if the teaching file is a stand-alone application, the teaching file may appear in a Windows™ menu in a PACS group (such as IMPAX™ for example) along with possibly a selection prompt. Further, the application may appear on the desktop.

As illustrated in FIG. 1, a “main” form of the display comprises and shows three sections showing a current teaching file, generally denoted by reference numerals, as follows:
1. A first section (generally referred to as a Tree View) which may contain a tree view representation of a teaching file folder or teaching file folders. Generally, only folders that a user has permissions to observe may appear in the Tree View.
2. A second section (generally referred to as Folder Contents) which shows the content of a currently selected folder. In this example, the selected folder is indicated in a text box at the top of the form and is listed as “\\Teaching file\Breast\Breast\AXILLA”.
3. A third section (generally referred to as a Teaching File Summary) which contains data which may be distinguished when a single teaching file is selected a folder contents grid. This section may also include teaching file comments and references, and reference links that may be opened in a URL, in a new window of a default web browser.

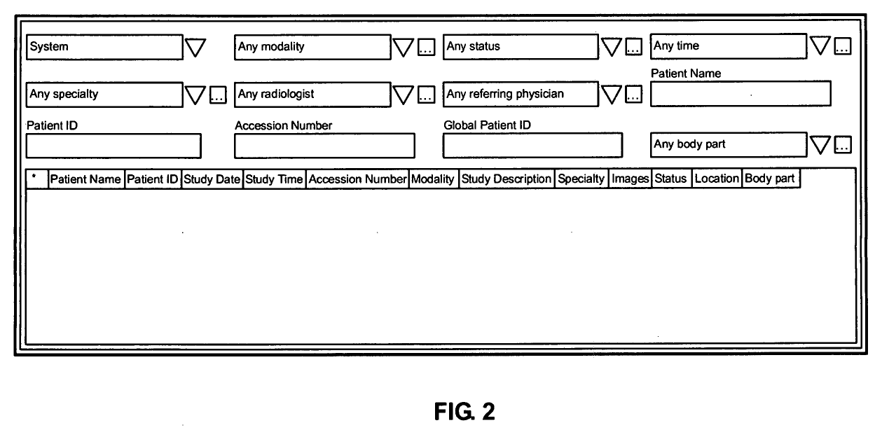

Additionally, a form of the display may also comprise the following:
A list of teaching files that a user may build (generally referred to as a work list), which may be used to perform group functions, such as for example: launch display, burn to CD, delete and copy, etc.
Where a teaching file is a standalone application, an area generally known as a finder grid window (bottom-half of FIG. 2) and another area generally known as a search criteria window (top-half of FIG. 2) may allow the user to search a database or a cluster of the PACS for studies that may be added to a teaching file. For better viewing, only one of these two windows need be visible at any given time, particularly where the user may not be adding studies to the teaching file and creating a work list concurrently.

In such a display, teaching files may be created by dropping objects into a current folder. They may also be created by dragging selected studies from a finder grid window and dropping them into a folder view (for example an IMPAX™ Select view). Alternatively, when working in an image type mode (for example an IMPAX™ Display mode), files may be created by dragging selected images and dropping them into a folder view. Modes may be created that allow a user to add to a study, a series and/or an object.

When an image is dragged and dropped onto a teaching file, the entire study or series to which that image belongs may be added to a teaching file depending on the mode that the system is in and/or possibly the type of selection made. For example, if the selection is in a mode generally known as an image mode only a selected image may be added to the teaching file.

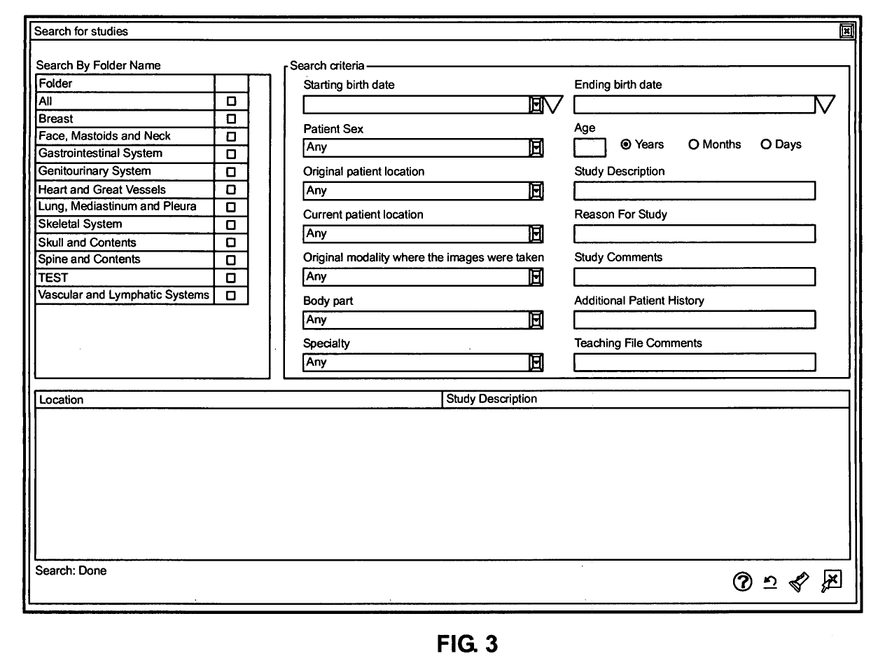

As illustrated in FIG. 3, another form referred to as a search form, may be accessible, which may contain an area displaying a list of folders contained at a root of a teaching file, wherein only the selected folders may be used during a search and/or a list to select search criteria from, and a search result list, displaying all teaching files uncovered that match a search criteria.

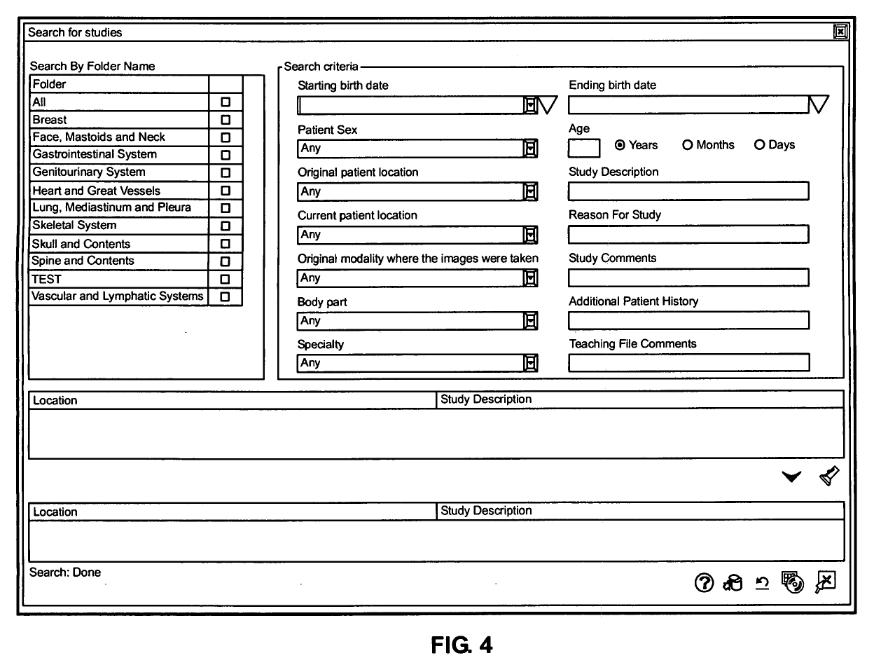

A further form, as illustrated in FIG. 4, is generally referred to as a CD export form. Such a form, which may be in addition to the search form described hereinabove, further comprises an input grid located near the bottom of FIG. 4, just above the text “Search: Done”, for a list of the studies the user wishes to burn to a CD. In the case where a work list function is implemented in the teaching file screen, an element such as a CD export button on a form such as the form illustrated in FIG. 1 may be available for a CD export with a current work list.

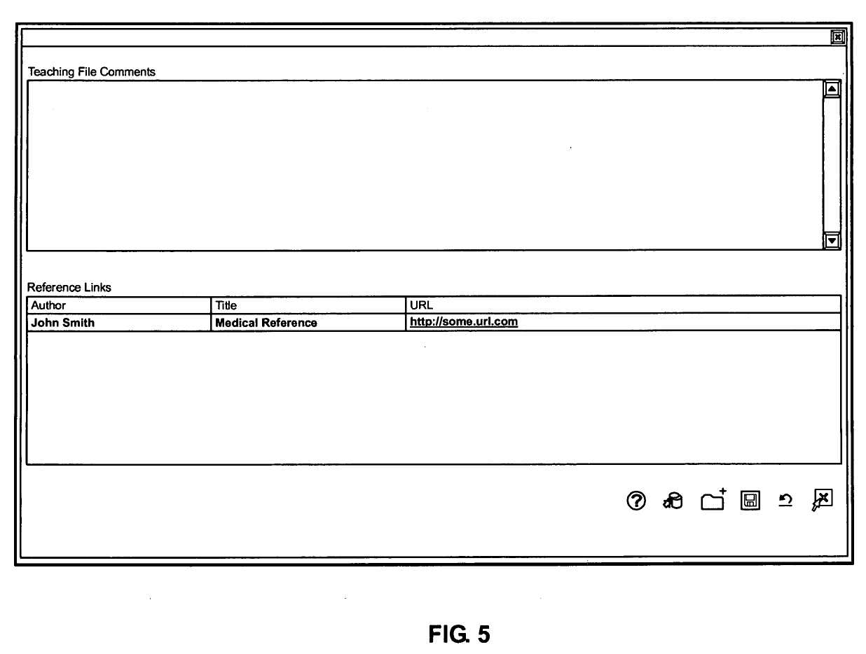

A form such as illustrated in FIG. 5, generally referred to as a Teaching File Comments form, may be used to add any extra notes that may be required to further describe a given teaching file. Added reference links may also further allow additional information to be associated with a teaching file, whereby clicking on a URL may open the URL in the user's default browser directly.

A person skilled in the art will appreciate that the system and method in accordance with an aspect of the present invention allows the use of DICOM data without converting it beforehand, or the need to prepare images of the teaching files in advance. The resulting images accessible to the user from the aforementioned system and method of the present invention are of an enhanced quality.

Although the present invention has been described hereinabove by way of embodiments thereof, it may be modified, without departing from the nature and teachings of the subject invention. Thus, the scope of the invention is defined by the following claims.

1. A computer implemented method for managing teaching files in a medical imaging system, comprising:
allowing selection of an element from a medical imaging database;
allowing indication of a teaching file for placement of a selected element;
isolating, in dependence upon at least one use characteristic of said teaching file, predetermined data associated with said selected element, such that access to said predetermined data through said teaching file is controlled.

2. The computer implemented method of claim 1, further comprising determining if said selected element is related to a previously placed element in said indicated teaching file, and if so, isolating corresponding predetermined data from said selected element in dependence upon established criteria for placement into said teaching file.

3. The computer implemented method of claim 2, wherein said isolating comprises copying said selected element without said predetermined data.

4. The computer implemented method of claim 2, wherein said isolating comprises hiding access to said predetermined data.

5. The computer implemented method of claim 1, wherein said isolating comprises copying said selected element without said predetermined data.

6. The computer implemented method of claim 1, wherein said isolating comprises hiding access to said predetermined data.

7. The computer implemented method of claim 6, further comprising maintaining a hidden link to said predetermined data.

8. The computer-implemented method of claim 1, wherein said predetermined data is any data field identifying a patient as a specific individual.

9. A system for managing teaching files in a medical imaging system, comprising:
means for selecting an element from a medical imaging database;
means for indicating a teaching file for placement of a selected element;
means for isolating, in dependence upon at least one use characteristic of said teaching file, predetermined data associated with said selected element, such that access to said predetermined data through said teaching file is controlled.

10. The system of claim 9, further comprising means for determining if said selected element is related to a previously placed element in said indicated teaching file, and if so, isolating corresponding predetermined data from said selected element in dependence upon established criteria for placement into said teaching file.

11. The system of claim 10, wherein said means for isolating comprises means for copying said selected element without said predetermined data.

12. The system of claim 10, wherein said means for isolating comprises means for hiding access to said predetermined data.

13. The system of claim 9, wherein said means for isolating comprises means for copying said selected element without said predetermined data.

14. The system of claim 9, wherein said means for isolating comprises means for hiding access to said predetermined data.

15. The system of claim 14, further comprising means for maintaining a hidden link to said predetermined data.

17. The system of claim 9, wherein said predetermined data is any data field identifying a patient as a specific individual.

18. A computer readable medium containing software instructions which, when executed in a computer, may be used to manage teaching files in a medical imaging system, comprising:
instructions for allowing selection of an element from a medical imaging database;
instructions for allowing indication of a teaching file for placement of a selected element;
instructions for isolating, in dependence upon at least one use characteristic of said teaching file, predetermined data associated with said selected element, such that access to said predetermined data through said teaching file is controlled.

19. The computer readable medium of claim 18, wherein said predetermined data is any data field identifying a patient as a specific individual.
